(19) United States
(12) Patent Application Publication
(10) Pub. No.: US 2024/0185084 A1
(43) Pub. Date: Jun. 6, 2024

(54) MULTI-OBJECTIVE REINFORCEMENT LEARNING USING WEIGHTED POLICY PROJECTION

(71) Applicant: DeepMind Technologies Limited, London (GB)

(72) Inventors: Abbas Abdolmaleki, London (GB); Sandy Han Huang, London (GB); Martin Riedmiller, Balgheim (DE)

(21) Appl. No.: 18/286,504

(22) PCT Filed: May 27, 2022
(86) PCT No.: PCT/EP2022/064493

§ 371 Date: Oct. 11, 2023

Related U.S. Application Data
(60) Provisional application No. 63/194,764, filed on May 28, 2021.

(51) Int. Cl. G06N 3/092

(52) U.S. Cl. CPC G06N 3/092

(57) ABSTRACT

Computer implemented systems and methods for training an action selection policy neural network to select actions to be performed by an agent to control the agent to perform a task. The techniques are able to optimize multiple objectives one of which may be to stay close to a behavioral policy of a teacher. The behavioral policy of the teacher may be defined by a predetermined dataset of behaviors and the systems and methods may then learn offline. The described techniques provide a mechanism for explicitly defining a trade-off between the multiple objectives.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system and method implemented as computer programs on one or more computers in one or more locations that learns to control an agent to perform a task whilst balancing tradeoffs.

In one aspect there is described a computer implemented method of training an action selection policy neural network defining an action selection policy used to select actions to be performed by an agent to control the agent to perform a task in an environment, the task having multiple associated objectives. In general one objective is to maximize a return from the environment for a task-related objective, i.e. a cumulative, time-discounted reward for the task-related objective. An additional objective may be to stay close to a prior behavioral policy, such as an action selection policy of a teacher. In some implementations the prior behavioral policy is defined by a dataset of prior behaviors and the system learns offline. In some implementations an additional objective may be to maximize an auxiliary reward based on, e.g., exploration, or to maximize a return from the environment for a second, different task-related objective. The described techniques provide a mechanism for explicitly defining a trade-off between these different objectives.

In implementations the method comprises obtaining data defining an updated version of the action selection policy for selecting an action for the agent in response to an observation of a state of the environment. The updated version of the action selection policy may be obtained based on the rewards, e.g. using a reinforcement learning technique. In some implementations the updated version of the action selection policy is a non-parametric update of a policy based on learned Q-values.

In implementations the method also obtains data defining a second action selection policy for selecting an action for the agent in response to an observation of a state of the environment. The second action selection policy may be that of a teacher or expert or, e.g., an action selection policy that aims to maximize an entropy of the selected actions or, e.g., that aims to maximize the return from the environment for a second, different task-related objective.

In implementations the method determines a first policy projection value dependent on an estimated measure of a difference between the updated version of the action selection policy and the action selection policy. In implementations the method also determines a second policy projection value dependent on an estimated measure of a difference between the second action selection policy and the action selection policy. The second action selection policy may be a version of the second action selection policy, e.g. according to the data defining the second action selection policy or a version obtained by sampling, e.g. weighted sampling, of this data.

The method determines a combined objective value from a weighted combination of the first policy projection value and the second policy projection value. The method trains the action selection policy neural network by adjusting the parameters of the action selection policy neural network to optimize the combined objective value e.g. by backpropagating gradients of the combined objective value.

The method can be generalized to more than two action selection policies. Thus some implementations of the method have three or more action selection policies, each being used to determine a respective policy projection value. Then all of the policy projection values may be combined using a weighted combination to determine the combined objective value.

There is also described an agent including a trained action selection policy neural network configured to select actions to be performed by the agent to control the agent to perform a task in an environment. In implementations the action selection policy neural network has been trained as described herein. The agent may be configured to implement a training method as described herein, e.g. so that the agent is configured to continue learning after initial training. For example the agent may include a training engine and one or more Q-value networks as described herein, for training the agent as described herein.

The systems and methods described herein provide a new approach to reinforcement learning that can perform better than previous techniques. For example the described techniques can achieve better outcomes, such as learning to perform a task better, e.g. with a higher probability of success, or with less energy or wear, or more accurately. They can learn faster than some previous approaches, using less computing resources and energy; and the training can involve less use of the agent, with less disruption or wear.

Some implementations of the system enable an agent to learn offline, i.e. solely from a dataset of training data without further interaction with the environment. The offline learning techniques described herein have an advantage that, although they can be guided by the example behavior in such a dataset, they can extend their actions beyond this behavior. The described techniques also allow an explicit choice of the weight to place on such example behavior.

Some implementations of the system also facilitate fine tuning of the behavior of an agent. For example the agent can be guided by a prior behavior policy defined by a teacher system but can also build upon this, learning to improve on the prior behavior policy by acting in the environment.

In implementations additional rewards, e.g. to regularize learning, are treated as separate objectives to that of maximizing a return from the environment for one or more explicitly task-related objectives.

Some implementations of the described systems and methods offer solutions to learning a task where trade-offs are involved. For example they can find a trade-off between objectives on a concave Pareto front. This can facilitate finding a better balance between competing objectives, e.g. a better overall combination of a task reward and cost; and can also facilitate identifying solutions that meet particular constraints.

Often reinforcement learning objectives need to be traded off against one another. The described techniques allow an intuitive balance to be specified for the reinforcement learning process, in terms of weights of the different objectives, and allows these weights to be adjusted to alter the trade-offs. Further, the described techniques do not require particular constraints to be met exactly for the different objectives.

A further advantage of the described techniques is that the weightings defining the trade-offs between objectives are scale-invariant: they are not defined with respect to reward scales, which typically can vary substantially between different rewards and over time; nor are they defined with respect to the scales of particular Q-values. Thus the choice of the weights is decoupled from the improvements in the objectives.

A still further advantage of the described techniques is that the weights may be adjusted over time. For example, where one of the objectives is to stay close to a prior behavior policy the reinforcement learning system may wish to stay close to this initially, to obtain maximum benefit from the teacher, but afterwards may wish to diverge to enable the system to improve beyond the teacher policy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system for training an action selection policy neural network.

FIG. 2 is a flow diagram of an example process for training the action selection policy neural network.

FIGS. 3A-3C illustrate the performance of an example of a system in training an action selection policy neural network.

Like reference numbers and designations in the various drawings indicate like elements.

### DETAILED DESCRIPTION

This specification describes reinforcement learning systems that can be used for online multi-objective learning, for fine tuning a teacher action-selection policy, and for offline reinforcement learning, where an agent learns from a dataset of demonstration data without further interactions with an environment.

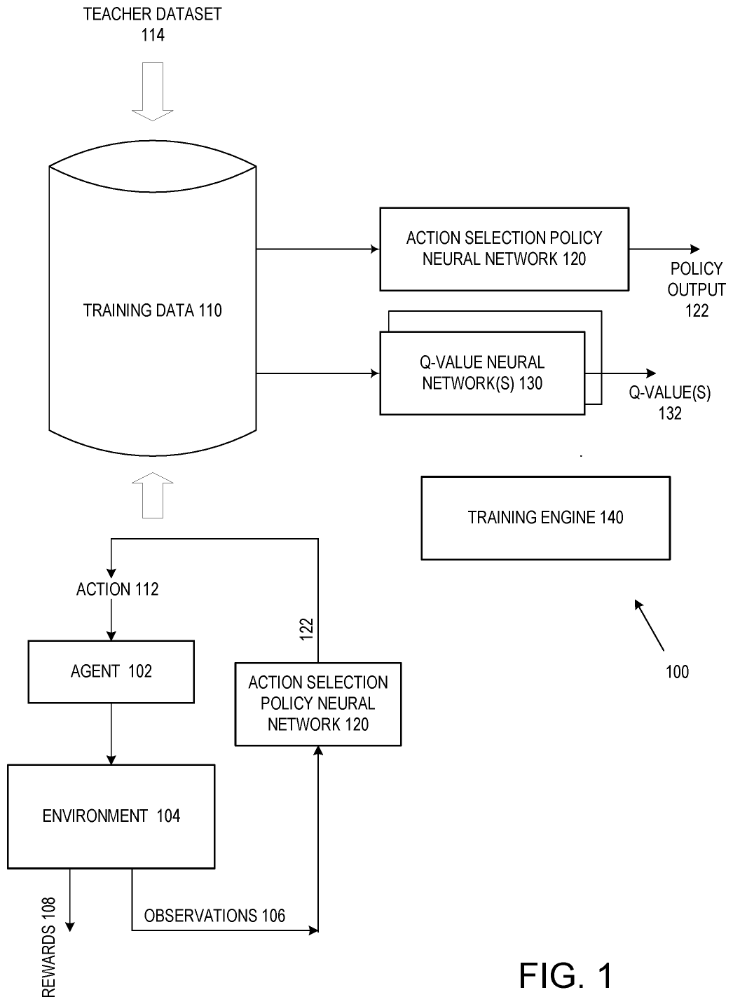

FIG. 1 shows an example of a system 100, that may be implemented as one or more computer programs on one or more computers in one or more locations, for training an action selection policy neural network 120. The action selection policy neural network 120 is used, during or after training, to control an agent 102 interacting with an environment 104 to select actions 112 to be performed by the agent to perform a task. The action selection policy neural network 120 is trained using observations 106 characterizing a state of the environment 104, based on rewards received subsequent to selected actions.

There are many applications of the system 100 and some example applications are described later. Merely as one example, the environment may be a real-world environment, and the agent may be a mechanical agent such as a robot or autonomous or semi-autonomous vehicle. Then the action selection policy neural network 120 may be trained to select actions to be performed by the mechanical agent in response to observations obtained from one or more sensors sensing the real-world environment, to control the agent to perform the task while interacting with the real-world environment. The action selection policy neural network 120 controls the agent by obtaining the observations of the environment and generating an action selection policy output that is used to select actions for controlling the agent to perform the task.

In some implementations an action selection policy neural network 120 is trained offline, that is based solely on a dataset of observations, actions and rewards and without interacting with the environment 104. The dataset may have been obtained from one or more demonstrations of performance of the task by a human or machine expert. In some implementations action selection policy neural network 120 is trained online, that is by interacting with the environment 104. In these implementations the training may be guided by a model action selection policy from a teacher e.g. another machine, i.e. by a model policy output from an action selection model; or the action selection policy neural network 120 may be trained without external guidance.

In FIG. 1 stored training data 110 represents data that may have been received from a teacher dataset 114, or that may have been generated by using the action selection policy neural network 120 to select actions performed in the environment 104. Generating the training data may involve obtaining an observation 106 of the state of the environment; processing the observation using the action selection policy neural network 120, in accordance with a current set of parameters of the action selection policy neural network 120, to generate an action selection policy output 122; selecting an action 112 to be performed by the agent 102 in response to the observation using the policy output 122; and causing the agent to perform the selected action and, in response, receiving a reward 108 characterizing progress made on the task. A reward may represent completion of or progress towards completion of the task.

In implementations the stored training data 110 defines a set of transitions. Each transition may comprise an observation characterizing a state of the environment at a time step and an action that was performed at the time step, a reward received subsequent to performing the action and, in implementations, a subsequent observation characterizing a subsequent state of the environment after performing the action. The action selection policy neural network 120 is trained using these observations and based on the rewards received subsequent to the selected actions, as described later.

The action selection policy neural network 120, may have any suitable architecture and may include, e.g., one or more feed forward neural network layers, one or more convolutional neural network layers, one or more recurrent neural network layers, one or more attention neural network layers, or one or more normalization layers. The policy output 122 may define the action directly, e.g., it may comprise a value used to define a continuous value for an action such as a torque or velocity, or it may parameterize a continuous or categorical distribution from which a value defining the action may be selected, or it may define a set of scores, one for each action of a set of possible actions, for use in selecting the action. Merely as one example the policy output 122 may define a multivariate Gaussian distribution with a diagonal covariance matrix.

The system 100 is configured to evaluate and update, i.e. improve, a current action selection policy implemented by the action selection policy neural network 120. In general this involves using a reinforcement learning technique based on the rewards received subsequent to selected actions. In particular implementations this done using Q-learning, more particularly by maintaining one or more Q-value neural networks 130 configured to process an observation of a state and an action for the agent, in accordance with a current set of parameters of the Q-value neural network(s) 130, to generate one or more respective Q-values 132. The Q-value neural network(s) 130, may have any suitable architecture and may include, e.g., one or more feed forward neural network layers, one or more convolutional neural network layers, one or more recurrent neural network layers, one or more attention neural network layers, or one or more normalization layers.

In general a Q-value is a state-action value, or expected return, for taking an action in a state characterized by an observation, and thereafter acting according to the action selection policy defined by the current values of the action selection policy neural network parameters. In general a return is a cumulative measure of the reward received as the agent interacts with the environment over multiple time steps, e.g. a time-discounted sum of rewards.

The task may have one or more task-related target objectives and each target objective may be represented by a respective Q-value. In general, implementations of the system allow the action selection policy neural network 120 to be trained whilst optimizing multiple objectives. In some implementations of the system one of the objectives is optimizing, e.g., maximizing, a Q-value for the task, and another of the objectives is maintaining the action selection policy close to an action selection policy represented by the teacher dataset 114 or by the model action selection policy. In some implementations the system is configured to train the action selection policy neural network 120 online whilst optimizing multiple different Q-values for the task, each representing a different target objective, such as a different reward, or a cost (i.e. a negative reward), as the agent attempts to perform the task, e.g. to maximize the reward(s) or to minimize the cost(s). Example costs in a real-world environment can include a penalty, e.g. for power or energy use, or for mechanical wear-and-tear.

In implementations the system 100 is configured to train a Q-value neural network 130, by using a reinforcement learning technique based on the rewards received, to optimize a first, task-related objective function. A second Q-value neural network 130, if present, may similarly be trained using a reinforcement learning technique and based on the rewards received, to optimize a second, task-related objective function. Any reinforcement learning (critic-learning) technique may be used to train the Q-value neural network(s) 130, e.g. using a 1-step or n-step return, e.g. a Retrace target (arXiv:1606.02647). In some implementations distributional Q-learning is used, e.g. a C51 algorithm as described in Bellemare et al., “A distributional perspective on reinforcement learning”, arXiv: 1707.06887. In general training a Q-value neural network involves adjusting values of the parameters of the Q-value neural network by backpropagating gradients of a task-related objective function, e.g. of a temporal difference based on a Q-value target.

A training engine 140 controls training of the action selection policy neural network 120, as described further below. In broad terms this involves improving the current action selection policy of the action selection policy neural network 120 whilst staying close to action selection policies for the different objectives. More specifically this involves finding an action selection policy that improves on the current action selection policy of the action selection policy neural network 120, e.g. to optimize the first task-related objective function, and also using data defining a second action selection policy for selecting an action for the agent in response to an observation of a state of the environment. The second action selection policy can be the model action selection policy, or can be represented by the teacher dataset 114, or can be determined by finding an action selection policy that improves the current action selection policy of the action selection policy neural network 120 to optimize the second task-related objective function.

To train the action selection policy neural network 120 the effects of these action selection policies are explicitly weighted before being summed to obtain a combined objective function, J(θ), that depends on the action selection policy neural network parameters, θ. The combined objective function is used to train the action selection policy neural network 120. The explicit incorporation of the trade-offs into the combined objective function allows the system to be used for offline reinforcement learning as it enables the effect of the teacher dataset 114 on the combined objective function to be computed, whereas with other approaches it is intractable. It also facilitates learning tradeoffs between the action selection policies for the different objectives. More specifically, training of the action selection policy neural network 120 involves using the combined objective function to project the action selection policies for the different objectives back to a space defined by the current parameter values of the action selection policy neural network.

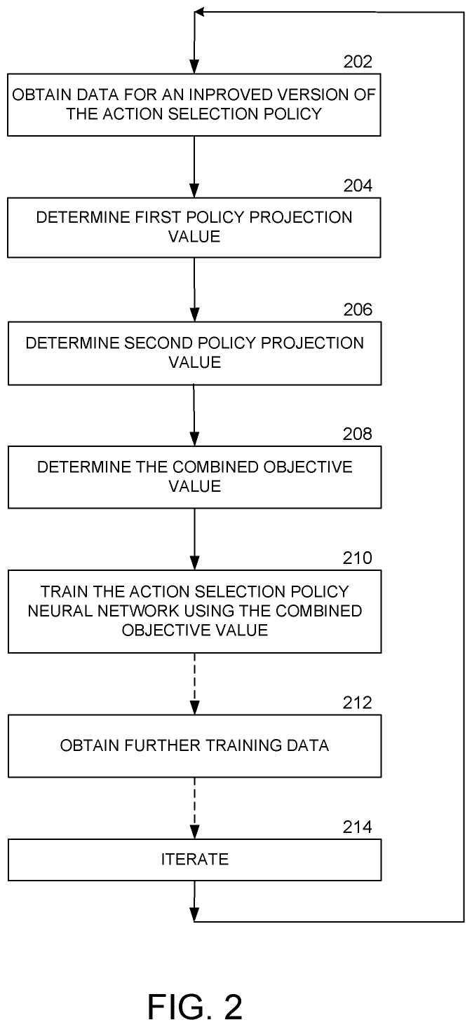

FIG. 2 is a flow diagram of an example process for using the system 100 to train an action selection policy neural network. The process of FIG. 2 may be implemented by one or more computers in one or more locations.

Referring to FIG. 2, training the action selection policy neural network 120 involves obtaining data defining an updated, in particular improved, version of the action selection policy for selecting an action for the agent in response to an observation of a state of the environment (step 202). More particularly the improved version of the action selection policy is obtained using reinforcement learning, using the observations and based on the rewards received subsequent to the selected actions. This can be done by using the Q-value neural network(s) 130 to evaluate the training data 110 and then determining the updated version of the action selection policy using the Q-value neural network(s) 130. The actions may have been selected using the policy output 122, or they may be from the teacher dataset 114.

The method then determines a first policy projection value dependent on a measure of a difference between the updated version of the action selection policy and the (current) action selection policy of the action selection policy neural network 120 (step 204). The method also determines a second policy projection value dependent on a measure of a difference between the second action selection policy and the (current) action selection policy of the action selection policy neural network 120 (step 206). In implementations the first policy projection value and the second policy projection value each comprise a measure of a KL divergence between the between the respective action selection policies i.e. between the updated version of the action selection policy and the (current) action selection, and between the second action selection policy and the (current) action selection policy.

The method then determines a combined objective value from a weighted combination of the first policy projection value and the second policy projection value (step 208). The weighted combination of the first policy projection value and the second policy projection value may comprise a sum of the first and second policy projection values respectively multiplied by a first weight and second weight. The weights in the weighted combination may sum to one.

Although determining the first and second policy projection values and determining the combined objective value are shown as separate steps in FIG. 2 for clarity, in practice they may be combined into a single step to determine the combined objective value, as described below.

The action selection policy neural network 120 is trained by adjusting the parameters of the action selection policy neural network to optimize the combined objective value, e.g. by backpropagating gradients of the combined objective function into the action selection policy neural network 120 (step 210).

In implementations steps 202-210 of the process are performed iteratively (step 214). In some implementations this involves obtaining further training data generated by using the action selection policy neural network to select actions in the environment (step 212).

Obtaining the further training data may comprise, at each of one or more time steps, obtaining an observation of the state of the environment, processing the observation using the action selection policy neural network to generate the policy output 122, and selecting an action to be performed by the agent in response to the observation using the policy output 122. The agent may then be caused to perform the selected action, e.g. by controlling the agent to perform the action, and in response a reward (that may be zero) is received characterizing progress made on the task. A state, action, reward, and optionally next state transition, (s, a, r, s′), for the time step may be stored in a replay buffer

In an offline setting no new training data is obtained but nonetheless the trained action selection policy neural network 120 influences the Q-learning, and hence obtaining the improved version of the action selection policy for a next iteration. For example for a dataset of transitions comprising state, action, reward, next state transitions (s, a, r, s′) training the Q-value neural network may involve determining an action from s′ using the action selection policy neural network, for bootstrapping.

In some implementations of the system the process may also involve adjusting the weights in the weighted combination, e.g. to optimize a trade-off across the objectives, to optimize a reward or return from the environment (step 214). This may be done manually or automatically, and is described further later. In some implementations the weights sum to a defined value such as 1. In that case the weighted combination of the first policy projection value and the second policy projection value may be defined by a single weight.

One particular example of obtaining data defining the updated version of the action selection policy is now described. The policy output 122, defining the action selection policy of the action selection policy neural network 120, for selecting an action a when the environment is in state s, may be denoted π(a|s). Then an updated version of the action selection policy, i.e. an improved action distribution, q(a|s), may be determined by multiplying π(a|s) by a policy improvement factor exp(Q(s,a)/η), where Q(s,a) is the Q-value from the Q-value neural network 130 for action a and state s and η is a temperature parameter. For example q(a|s), may be determined as

$$\\ q ( a \vert s ) = \frac{1}{z} π ( a \vert s ) exp ( Q ( s , a ) / η ) ,$$

where Z is a normalization constant that may be estimated e.g. by sampling actions for each state.

The policy improvement factor acts as a weight on the action probabilities. It may, e.g., aim to maximize an average of the Q-values over the states (observations) in the training data when paired with actions selected according to the updated (improved) action distribution. In general any improvement operator can be used to obtain q(a|s) and the described techniques are not limited to the particular policy improvement factor exp(Q(s,a)/η). For example in principle a neural network could be maintained to approximate q(a|s).

The temperature parameter η controls how greedy the improved policy, q(a|s), is with respect to Q(s,a), i.e. the emphasis placed on Q(s,a). The temperature parameter may be a fixed hyperparameter of the system or a learned parameter, e.g. learned by optimizing η[ϵ+ [symbol] _{μ} log [symbol] _{π} exp(Q(s,a)/η)] where ϵ is an optional constraint value, the expectation μ is over the states in the training data, and the expectation π is over actions selected by π(a|s).

As described herein the temperature parameter is independent of the weights in the weighted combination, which decouples the improvement operator from the choice of weights in the weighted combination. This facilitates applying the described techniques to offline settings and to behavioral fine tuning, and also facilitates intuitive interpretation of a combination of objectives specified by a particular combination of weights. Merely as an illustrative example, in one particular implementation η≈10.

Where there are multiple Q-value neural networks 130, each generating a respective Q-value Qₖ(s,a), multiple improved policies, qₖ(a|s) may be determined, each for a respective task-relative objective function, for training the action selection policy neural network 120 to optimize multiple objectives.

As previously described, the improved action selection policy and the second action selection policy are used to determine policy projection values that in turn are used to determine the combined objective value, that is optimized by training the action selection policy neural network. This projects the improved action selection policy and the second action selection policy into a space of parametric policies defined by the parameters of the action selection policy neural network.

More specifically, this projection can be expressed as determining the combined objective function, J(θ), according to:

$$\\ J ( θ ) = {𝔼}_{s \sim μ} {\sum }_{k = 1}^{K} {α}_{k} {D}_{KL} ( q ( \cdot \vert s ) ‖ π ( \cdot \vert s ) )$$

where k labels the first and second, and in general K, policy projection values, such that q₁(a|s) is the updated (improved) action selection policy, q₂(a|s) is the second action selection policy, and so forth. π(⋅|s) is the (current) action selection policy, and αₖ is a weight for the kth policy projection value. The weights may be in a weight range, e.g. [0,1]. D_{KL} is a metric of a difference between distributions defined by q(⋅|s) and π(⋅|s), e.g. the Kullbeck-Leibler divergence. The expectation comprises an expectation, e.g. average, over states in the training data, e.g. sampled from the replay buffer or from the dataset of transitions.

Some techniques for evaluating J(θ) in accordance with this approach are described below for cases where the second action selection policy is the model action selection policy or is represented by the teacher dataset 114.

Where the action selection policy neural network 120 is to optimize both the first and second task-related objective functions, i.e. for multi-objective reinforcement learning, J(θ) may be evaluated using the improved policies, qₖ(a|s). For example the data defining the second action selection policy, q₂(a|s), may be derived from a second Q-value neural network configured to process an observation of a state and an action for the agent to generate a second Q-value, Q₂(s,a). The second Q-value neural network may be trained by reinforcement learning, using the training data, to optimize a second, task-related objective function. For example the first, task-related objective may relate to successful performance of the task e.g. based on a reward for approaching completion of, or completing, the task. The second, task-related objective may be an objective to minimize an energy expenditure during performance of the task, e.g. based on a negative reward (penalty) dependent on energy expenditure during the task.

In a similar way a further Q-value neural network may be maintained, configured to process an observation of a state and an action for the agent to generate a further Q-value, Q₃(s,a). The further Q-value neural network may be trained by reinforcement learning using the training data to optimize a further, task-related objective function. Then the further Q-value neural network may be used to obtain data defining a second updated version of the action selection policy, q₃(a|s), for example as q₃(a|s)∝π(a|s) exp(Q₃(s,a)/η₃). A third policy projection value may then be determined dependent on a measure of a difference between the second updated version of the action selection policy and the action selection policy, and the combined objective value determined from a weighted combination of the first, second and third policy projection values.

In general in a multi-objective implementation, a value for the combined objective J(θ)= [symbol] _{s˜μ} [symbol] _{π}Σₖ₌₁^{K}[(αₖ/Zₖ(s))exp(Qₖ(s,a)/ηₖ)] may be determined by Monte Carlo sampling of states s from the replay buffer, then sampling actions for each state using the (current) action selection policy π(⋅|s). The samples may then be used to compute weights αₖ multiplied by exp(Qₖ(s,a)/ηₖ) and the normalization constant across states, Zₖ(s).

In some implementations the second action selection policy is the model action selection policy, i.e. a behavioral policy, π_{b}, of the action selection model, and the data defining the second action selection policy comprises data from the model policy output of the action selection model. The action selection model is configured to process an input from an observation representing a state of the environment, and to generate the model policy output for selecting an action for the agent. In these implementations the action selection model acts as a teacher for the action selection policy and may comprise, e.g., a trained neural network. In general the action selection model defines a behavioral prior for the action selection policy. Access is not needed to internal parameters of the action selection model, e.g. to weights of the trained neural network.

The difference between the behavioral policy, π_{b}(a|s), and the action selection policy π(a|s) may be expressed as the ratio

$$\\ log \frac{{π}_{b} ( a \vert s )}{π ( a \vert s )} .$$

Determining the second policy projection value may comprise evaluating this ratio. For example determining the second policy projection value may comprise sampling one or more observations of states of the environment from the training data, and determining one or more actions corresponding to the sampled observations according to the action selection policy defined by the action selection policy neural network, π(a|s). Then the logarithm of the ratio may be determined for each sampled state and action pair. In particular the logarithm of the ratio may be determined as the logarithm of a ratio of i) the model policy output from the action selection model for the sampled state and for the action, to ii) the policy output from the action selection policy neural network for the sampled state and for the action. In particular implementations the second policy projection value may be determined by averaging, over the determined states and actions, a product of a logarithm of the policy output network for the sampled state and for the action and an exponential function of the logarithm of the ratio.

Such an approach can be used to improve upon or “fine tune” the behavioral policy π_{b}(a|s) of another system, e.g. of another neural network-based action selection system. The value of the ratio

$$\\ log \frac{{π}_{b} ( a \vert s )}{π ( a \vert s )}$$

can be evaluated pointwise for the sampled states and actions.

In some implementations the combined objective value, J(θ), may be determined from the weighted combination of the first policy projection value and the second policy projection value as:

$$\\ J ( θ ) = {𝔼}_{\begin{matrix}s \sim μ \\ a \sim π\end{matrix}} [ ( ( \frac{1 - α}{{Z}_{1} ( s )} ) exp ( \frac{Q ( s , a )}{{η}_{1}} ) + ( \frac{α}{{Z}_{2} ( s )} ) exp ( \frac{log \frac{{π}_{b} ( a \vert s )}{π ( a \vert s )}}{{η}_{2}} ) ) log {}_{} π ( a \vert s ) ]$$

where the relative weights of the two terms in the weighted combination are determined by a weight α (e.g. if α₁+α₂=1). Q(s,a) is a state-action value for a task-related objective, as previously, Z₁(s) and Z₂(s) are normalizing constants that normalize the product of log π(a|s) and the corresponding exponential term (exp(⋅)) across states, as previously described, η₁ and η₂ are temperature parameters as previously described, and the expectation (average) is taken over states sampled from the replay buffer and actions sampled from the action selection policy log π(a|s).

In some implementations, e.g. in offline learning, the second action selection policy is represented by the teacher dataset 114. In these implementations it is not possible to directly interrogate the behavioral policy, π_{b}, and instead the behavioral policy, π_{b} is represented by the teacher dataset 114.

In implementations the teacher dataset 114, which defines the second action selection policy, comprises a dataset of transitions each comprising an observation characterizing a state of the environment at a time step, an action that was performed at the time step, and a reward received subsequent to performing the action. A transition may also comprise an observation characterizing the state of the environment at a next time step.

Data defining an updated version of the action selection policy, q(a|s), may be obtained as previously described, using a reinforcement learning technique such a Q-learning, based on the states, actions, and rewards represented in the teacher dataset 114. More particularly the Q-value neural network 130 may be trained using the teacher dataset 114 and the updated, improved, version of the action selection policy, q(a|s) determined by multiplying π(a|s) by the previously described policy improvement factor exp(Q(s,a)/η).

In implementations the teacher dataset 114 comprises a set of transitions, (s, a, r, s′), sampled from the behavioral policy, π_{b}, and the ratio

$$\\ log \frac{{π}_{b} ( a \vert s )}{π ( a \vert s )}$$

cannot be evaluated directly. Instead, determining the second policy projection value may comprise sampling one or more observations of states of the environment from the dataset, sampling one or more actions corresponding to the sampled observations from the dataset, and averaging a logarithm of a policy output from the action selection policy neural network for each sampled state and action pair. In a variant, the averaged logarithm is weighted by a state-action advantage value for the sampled state and action pair, i.e. a difference between a Q-value for the state and a state value that defines a baseline value for the state.

As one particular example the combined objective value, J(θ), may be determined from the weighted combination of the first policy projection value and the second policy projection value as:

$$\\ J ( θ ) = ( 1 - α ) {}_{} {𝔼}_{\begin{matrix}s \sim μ \\ a \sim π\end{matrix}} [ \frac{1}{{Z}_{1} ( s )} exp ( \frac{Q ( s , a )}{η} ) {}_{} log {}_{} π ( a \vert s ) ] + α {}_{} {𝔼}_{\begin{matrix}s \sim μ \\ a \sim {π}_{b}\end{matrix}} [ log {}_{} π ( a \vert s ) ]$$

where the variables are as previously defined. Determining the expectation in the first term involves averaging over states (observations) sampled from the teacher dataset 114 and over corresponding actions selected using the action selection policy log π(a|s). Determining the expectation in the second term involves averaging over states (observations) and corresponding actions both sampled from the teacher dataset 114. Implementations of this approach allow the system to exploit Q-value estimates for actions beyond those taken by the “expert” as defined by the teacher dataset 114.

The second term may be weighted by an (exponentiated) advantage function A(s,a)=Q(s,a)−V(s) where V(s) is a state value function. For example, the second term may be defined as

$$\\ α {}_{} {𝔼}_{\begin{matrix}s \sim μ \\ a \sim {π}_{b}\end{matrix}} [ exp ( A ( s , a ) ) log {}_{} π ( a \vert s ) ] .$$

In general the state value represents a baseline value of the environment being in the current state to successfully performing the specified task. More specifically it may represent the expected return from a state when acting according to the action selection policy defined by the current values of the action selection policy neural network parameters. The state value may be generated by a value neural network, e.g. another head on the Q-value neural network, trained like the Q-value network, e.g. by regressing to a 1-step or n-step return. This provides an alternative way of measuring/ensuring closeness to the behavioral policy, π_{b}. When weighted in this way the described technique may be referred to as that may be referred to as DiME (AWBC), i.e. Distillation of a Mixture of Experts, Advantage Weighted Behavior Cloning; without this weighting the technique may be referred to as DiME BC (Behavior Cloning).

Optionally in the above described implementations the evaluation of J(θ) may be subject to additional constraints e.g. a trust-region or soft KL-constraint on q(a|s) or on a mean or covariance of the policy output 122.

In some implementations weight α or weights αₖ may be chosen by random sampling to identify an optimum selection, e.g. that on average achieves high rewards or returns. For example weights may be randomly sampled from a uniform or other distribution over the range [0,1] or systematically sampled, e.g. step-by-step over the range.

In some implementations the action selection policy neural network is conditioned on a trade-off between projection values, and corresponding objectives, defined by the weight(s). The weighted combination of the first policy projection value and the second policy projection value may be defined by a weight vector, α, with one or more elements corresponding to the one or more weights. Then the action selection policy neural network may be configured to process the observation and the weight vector to generate the policy output 122. Such a weight-conditioned action selection policy may be denoted π(a|s,α).

Similarly the one or more Q-value neural networks 130 may be configured to process an observation of a state, an action for the agent, and the weight vector, α, to generate the one or more respective Q-values 132, Q(s,a,α). The updated (improved) version of the action selection policy may be determined as

$$\\ q ( a \vert s , \underline{α} ) = \frac{1}{z} π ( a \vert s , \underline{α} ) exp ( Q ( s , a , \underline{α} ) / η ) .$$

The weight vector, α, may be adjusted to optimize the reward or return from the environment, e.g. by randomly or systematically sampling values for the weight vector during the training of the action selection policy neural network, or by automatically adjusting the weight vector to optimize the rewards, e.g. by reinforcement learning. Searching for an optimum trade-off between objectives, i.e. an optimum weight vector, α, can help to compensate for inaccurate learned Q-values, e.g. in an offline setting.

In one example implementation the weight vector may be learned by updating α based on the loss:

$$\\ J ( \underline{α} ) = \underline{α} {}_{} ( {}_{} {𝔼}_{\begin{matrix}s \sim μ \\ a \sim π ( \cdot \vert s )\end{matrix}} Q ( s , a ) - c {}_{} )$$

where c is a hyperparameter that defines a threshold for staying close the behavioral policy, π_{b}, or to the behavioral policy defined by the teacher dataset 114. That is, the system stays close the behavioral policy while the expected return is less than the threshold c and otherwise optimizes for the bootstrapped Q-function. A value of c may be chosen based on an expected return from fully imitating the behavioral policy. A sigmoid function may be applied to constrain values of α to [0,1].

A Pareto front is defined by a set of Pareto optimal policies, where a Pareto optimal policy is an action selection policy for which the return from one target objective of the action selection policy cannot be improved without reducing the return from another target objective. With unconstrained multi-objective reinforcement learning there is generally no single optimal policy, but a set defining the Pareto front. In an online multi-objective setting implementations of the system in which the action selection policy is conditioned on the weights can find optimal solutions along an entire Pareto front, even when the Pareto front is concave. Thus the system can be optimized for multiple task-related rewards (or penalties) simultaneously, and an optimal solution can then selected from a range of possible optimal solutions, e.g. in accordance with other desired characteristics or to meet one or more desired constraints.

As previously mentioned, the techniques described herein do not rely upon any particular system or neural network architecture. However merely as an example, the techniques may be implemented in the context of an actor-learner configuration, e.g. an asynchronous configuration with multiple actors. In such an arrangement each actor fetches parameters for the action selection policy neural network 120 from the learner and acts in the environment, storing transitions in the replay buffer. The learner samples batches of transitions from the replay buffer and uses these to update the action selection policy neural network and Q-value neural network(s) 130. In an offline setting, the dataset of transitions is typically given and fixed (i.e. there are no actors) and the learner samples batches of transitions from that dataset.

Optionally to stabilize learning a target neural network may be maintained for each trained neural network. The target networks are used for computing gradients, e.g. using an optimization algorithm such as Adam, optionally with weight decay. At intervals, e.g. every fixed number of steps, the parameters of the target neural network are updated to match the parameters online neural network.

In implementations where the action selection policy neural network 120 is conditioned on trade-offs. The trade-off may be fixed for each episode. For example, at the start of each episode, an actor may sample a trade-off comprising one or more weights, α, e.g. from a distribution as α˜v(α), and may then act based on π(a|s,α) during the episode. At the start of the next episode the actor may sample a different trade-off and repeat the process.

In some implementations the action selection policy neural network 120 and the Q-value neural network(s) 130 are feedforward neural networks with ELU (exponential linear unit) activation, and optionally layer normalization. In implementations the policy output from the action selection policy neural network is parameterized as a Gaussian distribution with a diagonal covariance matrix.

The Table below illustrates the performance of an example of the system described herein implemented for offline learning. The system is compared with other algorithms, for various different offline learning tasks from RL Unplugged (Gulcehre et al. “RL unplugged: A suite of benchmarks for offline reinforcement learning”, Advances in Neural Information Processing Systems 33—NeurIPS 2020). The Table shows the performance of DiME (BC) and DiME(AWBC), and “multi” versions of these (which involved training ten policies with different random seeds), compared with a behavioral cloning (BC) baseline (that optimizes for

$$\\ {𝔼}_{( s , a ) {}_{} \sim {D}_{{π}_{b}}} log {}_{} π ( a \vert s ) ;$$

Gulchere et al. ibid); BCQ (Gulchere et al. ibid); BRAC (Gulchere et al. ibid); MZU (MuZero Unplugged, Schrittwieser et al., “Online and offline reinforcement learning by planning with a learned model”, arXiv:2104.06294); and LS (CRR) (Wang et al. 2020, “Critic regularized regression”, NeurIPS 2020, referred to there as “CRR exp”).

| | | | | | LS | DiME | DiME | | | | DiME | DiME |
|---|---|---|---|---|---|---|---|---|---|---|---|---|
| | | | | | (CRR) | (BC) | (AWBC) | LS | DiME | DiME | (BC) | (AWBC) |
| Task | BRAC | CRR† | MZU | BC | α =.3 | α = .45 | α = .5 | (CRR) | (BC) | (AWBC) | multi | multi |
| cartpole swingup | 869 | 664 | 343 | 380 | 677 | 865 | 832 | 843 | 882 | 881 | 878 ± 1 | 878 ± 1 |
| cheetah run | 539 | 577 | 799 | 376 | 628 | 705 | 759 | 796 | 733 | 759 | 808 ± 7 | 802 ± 9 |
| finger turn hard | 227 | 714 | 405 | 132 | 360 | 741 | 837 | 515 | 885 | 892 | 899 ± 7 | 903 ± 4 |
| fish swim | 222 | 517 | 585 | 493 | 566 | 652 | 665 | 613 | 652 | 669 | 721 ± 4 | 701 ± 6 |
| humanoid run | 10 | 586 | 633 | 390 | 507 | 596 | 582 | 635 | 638 | 660 | 636 ± 3 | 661 ± 2 |
| manip insert ball | 56 | 625 | 557 | 370 | 575 | 554 | 578 | 603 | 652 | 626 | 699 ± 5 | 709 ± 3 |
| manip insert peg | 50 | 387 | 433 | 261 | 409 | 304 | 281 | 410 | 386 | 435 | 432 ± 7 | 436 ± 8 |
| walker stand | 829 | 797 | 760 | 286 | 672 | 783 | 861 | 706 | 955 | 951 | 964 ± 1 | 967 ± 1 |
| walker walk | 786 | 901 | 902 | 361 | 865 | 842 | 796 | 868 | 955 | 957 | 961 ± 1 | 962 ± 1 |
| mean score | 399 | 641 | 602 | 339 | 584 | 671 | 688 | 665 | 749 | 759 | 778 | 780 |

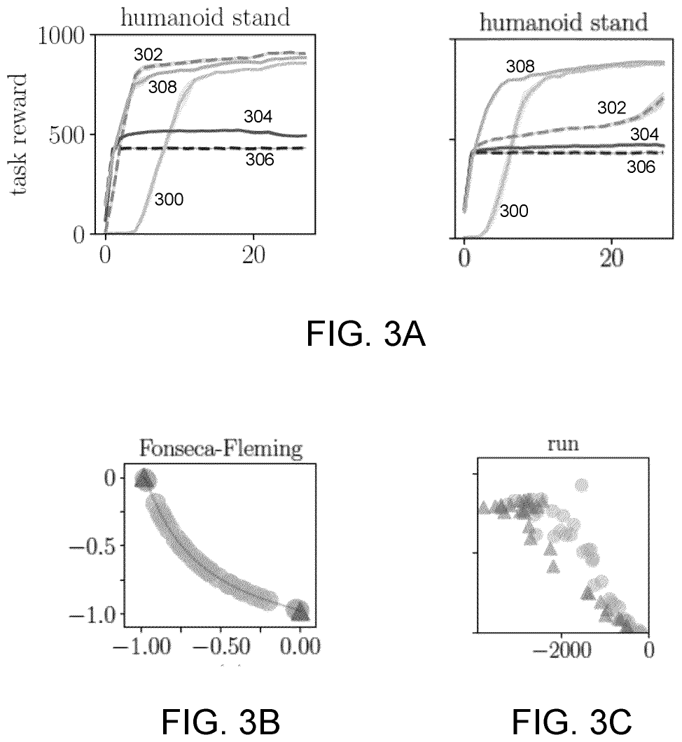

FIG. 3A illustrates the performance of an example of the system described herein implemented to fine tune a teacher action-selection policy (the x-axis is actor steps×10⁶). The graphs compare the results of a “humanoid stand” learning task for DiME (left) and an approach (right) in which the trade-offs are taken into account in the policy improvement rather than the projection step. A suboptimal humanoid stand policy is used as the prior behavior policy.

The graphs show the effect of different values of α, from α=0, curve 300, which corresponds to learning from scratch; through α=0.25, curve 302, and α=0.5, curve 304, to α=1, curve 306, which corresponds to fully imitating the prior behavior policy. A curve 308 is included for a value of α that is learned as described above. It can be seen that the weighted combination allows a trade-off to be selected that learns faster and achieves a higher final reward than learning from scratch or simply imitating the prior behavior policy. Also the described technique (“DiME”) learns faster, and achieves a higher final reward, than an approach in which trade-offs are taken into account in the policy improvement step.

FIG. 3B illustrates the illustrates the performance of an example of the system described herein implemented for multi-objective learning. FIG. 3B relates to a toy task based on a Fonseca-Fleming function with a concave Pareto front. The x- and y-axes show the average task reward for two different rewards; the circles are for DiME and the triangles are for the above described alternative approach in which trade-offs are taken into account in the policy improvement step. FIG. 3B illustrates that DiME is able to find solutions along the entire Pareto front whereas the alternative approach only finds solutions at the extremes of the function.

FIG. 3C also illustrates the performance of an example of the system described herein implemented for multi-objective learning. FIG. 3C relates to a humanoid run task; the x-axis shows an average negative action norm cost, which corresponds to an energy penalty on actions of −∥a∥₂. The y-axis shows the average task rewards. The circles and triangles are as for FIG. 3B. It can be seen that the DiME technique described herein finds better solutions i.e. solutions with higher rewards (higher up the y-axis) and lower costs (further right along the x-axis). The hypervolume of the DiME solution is 2.58×10⁶, compared with 1.75×10⁶ for the alternative approach; and compared with 2.15×10⁶ for an approach based on MO-MPO (Abdolmaleki et al. “A distributional view on multi-objective policy optimization”, Proc. 37^{th} Int. Conf. in Learning Representations, ICLR, 2018) not shown in FIG. 3C.

In some implementations of the method the environment is a real-world environment. The agent may be mechanical agent such as a robot interacting with the environment to accomplish a task or an autonomous or semi-autonomous land or air or water vehicle navigating through the environment. In some implementations the action selection neural network may be trained using a simulation of a mechanical agent in a simulation of a real-world environment, in order for the action selection neural network then to be used to control the mechanical agent in the real-world environment. The observations may then relate to the real-world environment in the sense that they are observations of the simulation of the real-world environment. The actions may relate to actions to be performed by the mechanical agent acting in the real-world environment to perform the task in the sense that they are simulations of actions that will later be performed in the real-world environment. Whether or not partially or completed trained in simulation, after training the action selection neural network may be used to control the mechanical agent to perform the task while interacting with the real-world environment by obtaining the observations from one or more sensors sensing the real-world environment and using the policy output to select actions to control the mechanical agent to perform the task.

In general the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g. one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment. As used herein an image includes a point cloud image e.g. from a LIDAR sensor.

The actions may comprise control signals to control a physical behavior of the mechanical agent e.g. robot, e.g., torques for the joints of the robot or higher-level control commands; or to control the autonomous or semi-autonomous land or air or sea vehicle, e.g., torques to the control surface or other control elements of the vehicle or higher-level control commands. In other words, the actions can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the signals may define actions to control navigation e.g. steering, and movement e.g. braking and/or acceleration of the vehicle.

In such applications the task-related rewards may include a reward for approaching or achieving one or more target locations, one or more target poses, or one or more other target configurations, e.g. to reward a robot arm for reaching a position or pose and/or for constraining movement of a robot arm. A cost may be associated with collision of a part of a mechanical agent with an entity such as an object or wall or barrier. In general a reward or cost may be dependent upon any of the previously mentioned observations e.g. robot or vehicle positions or poses. For example in the case of a robot a reward or cost may depend on a joint orientation (angle) or speed/velocity e.g. to limit motion speed, an end-effector position, a center-of-mass position, or the positions and/or orientations of groups of body parts; or may be associated with force applied by an actuator or end-effector, e.g. dependent upon a threshold or maximum applied force when interacting with an object; or with a torque applied by a part of a mechanical agent. In another example a rewards or cost may depend on energy or power usage, motion speed, or a positions of e.g. a robot, robot part or vehicle

A task performed by a robot may be, for example, any task which involves picking up, moving, or manipulating one or more objects, e.g. to assemble, treat, or package the objects, and/or a task which involves the robot moving. A task performed a vehicle may be a task which involves the vehicle moving through the environment.

The above described observations, actions, rewards and costs may be applied to a simulation of the agent in a simulation of the real-world environment. Once the system has been trained in the simulation, e.g. once the neural networks of the system/method have been trained, the system/method be used to control the real-world agent in the real-world environment. That is control signals generated by the system/method may be used to control the real-world agent to perform a task in the real-world environment in response to observations from the real-world environment. Optionally the system/method may continue training in the real-world environment.

In some applications the environment is a networked system, the agent is an electronic agent, and the actions comprise configuring settings of the networked system that affect the energy efficiency or performance of the networked system. A corresponding task may involve optimizing the energy efficiency or performance of the networked system. The networked system may be e.g. an electric grid or a data center. For example the described system/method may have a task of balancing the electrical grid, or optimizing e.g. renewable power generation (e.g. moving solar panels or controlling wind turbine blades), or electricity energy storage e.g. in batteries; with corresponding rewards or costs, the observations may relate to operation of the electrical grid, power generation, or storage; and the actions may comprise control actions to control operation of the electrical grid, power generation, or energy storage.

In some applications the agent comprises a static or mobile software agent i.e. a computer programs configured to operate autonomously and/or with other software agents or people to perform a task. For example the environment may be a circuit or an integrated circuit design or routing environment and the agent may be configured to perform a design or routing task for routing interconnection lines of a circuit or of an integrated circuit e.g. an ASIC. The reward(s) and/or cost(s) may then be dependent on one or more design or routing metrics such as interconnect length, resistance, capacitance, impedance, loss, speed or propagation delay; and/or physical line parameters such as width, thickness or geometry, and design rules; or may relate to a global property such as operating speed, power consumption, material usage, cooling requirement, or level of electromagnetic emissions. The observations may be e.g. observations of component positions and interconnections; the actions may comprise component placing actions e.g. to define a component position or orientation and/or interconnect routing actions e.g. interconnect selection and/or placement actions. The process may include outputting the design or routing information for manufacture, e.g. in the form of computer executable instructions for manufacturing the circuit or integrated circuit. The process may include making the circuit or of integrated circuit according to the determined design or routing information.

In some applications the agent may be an electronic agent and the observations may include data from one or more sensors monitoring part of a plant, building, or service facility, or associated equipment, such as current, voltage, power, temperature and other sensors, and/or electronic signals representing the functioning of electronic and/or mechanical items of equipment e.g. computers or industrial control equipment. The agent may control actions in a real-world environment including items of equipment, for example in a facility such as: a data center, server farm, or grid mains power or water distribution system, or in a manufacturing plant, building, or service facility. The observations may then relate to operation of the plant, building, or facility, e.g. they may include observations of power or water usage by equipment or of operational efficiency of equipment, or observations of power generation or distribution control, or observations of usage of a resource or of waste production, or observations of the environment, e.g. air temperature. The actions may include actions controlling or imposing operating conditions on items of equipment of the plant/building/facility, and/or actions that result in changes to settings in the operation of the plant/building/facility e.g. to adjust or turn on/off components of the plant/building/facility. The equipment may include, merely by way of example, industrial control equipment, computers, or heating, cooling, or lighting equipment. The reward(s) and/or cost(s) may include one or more of: a measure of efficiency, e.g. resource usage; a measure of the environmental impact of operations in the environment, e.g. waste output; electrical or other power or energy consumption; heating/cooling requirements; resource use in the facility e.g. water use; or a temperature of the facility or of an item of equipment in the facility. A corresponding task may involve optimizing a corresponding reward or cost to minimize energy or resource use or optimize efficiency.

More specifically, in some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some applications the environment may be a data packet communications network environment, and the agent may comprise a router to route packets of data over the communications network. The task may comprise a data routing task. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) or cost(s) may be defined in relation to one or more of the routing metrics i.e. to maximize or constrain one or more of the routing metrics.

In some other applications the agent is a software agent which has a task of managing the distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The reward(s) or cost(s) may be to maximize or limit one or more of: utilization of computing resources, electrical power, bandwidth, and computation speed.

In some other applications the environment may be an in silico drug design environment, e.g. a molecular docking environment, and the agent may be a computer system with the task of for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. One or more rewards or costs may be defined based on one or more of: a measure of an interaction between the drug and the drug target e.g. of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waal interactions, electrostatic interactions, and/or a contact surface region or energy; it may comprise e.g. a docking score.

In some other applications the environment is an Internet or mobile communications environment and the agent is a software agent which manages a personalized recommendation for a user. The task may be to generate recommendations for the user. The observations may comprise previous actions taken by the user, e.g. features characterizing these; the actions may include actions recommending items such as content items to a user. The reward(s) or cost(s) may be to maximize or constrain one or more of: an estimated likelihood that the user will respond favorably to being recommended the (content) item, a suitability unsuitability of one or more recommended items, a cost of the recommended item(s), and a number of recommendations received by the user, optionally within a time span. In another example the recommendations may be for ways for the user to reduce energy use or environmental impact.

In some other applications the environment is a healthcare environment and the agent is a computer system for suggesting treatment for the patient. The observations may then comprise observations of the state of a patient e.g. data characterizing a health of the patient e.g. data from one or more sensors, such as image sensors or biomarker sensors, vital sign data, lab test data, and/or processed text, for example from a medical record. The actions may comprise possible medical treatments for the patient e.g. providing medication or an intervention. The task may be to stabilize or improve a health of the patient e.g. to stabilize vital signs or to improve the health of the patient sufficiently for them to be discharged from the healthcare environment or part of the healthcare environment, e.g. from an intensive care part; or the task may be to improve a likelihood of survival of the patient after discharge or to reduce long-term damage to the patient. The reward(s) or cost(s) may be correspondingly defined according to the task e.g. a reward may indicate progress towards the task e.g. an improvement in patient health or prognosis, or a cost may indicate a deterioration in patient health or prognosis.

Once trained the system may be used to perform the task for which it was trained, optionally with training continuing during such use. The task may be, e.g., any of the tasks described above. In general the trained system may be used to control the agent to achieve rewards or minimize costs as described above. Merely by way of example, once trained the system may be used to control a robot or vehicle to perform a task such as manipulating, assembling, treating or moving one or more objects; or to control equipment e.g. to minimize energy use; or in healthcare, to suggest medical treatments.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer implemented method of training an action selection policy neural network defining an action selection policy used to select actions to be performed by an agent to control the agent to perform a task in an environment, the task having multiple associated objectives, the method comprising:
obtaining data defining an updated version of the action selection policy for selecting an action for the agent in response to an observation of a state of the environment, by using a reinforcement learning technique based on rewards received subsequent to selected actions;
obtaining data defining a second action selection policy for selecting an action for the agent in response to an observation of a state of the environment;
determining a first policy projection value dependent on a measure of a difference between the updated version of the action selection policy and the action selection policy;
determining a second policy projection value dependent on a measure of a difference between the second action selection policy and the action selection policy;
determining a combined objective value from a weighted combination of the first policy projection value and the second policy projection value; and
training the action selection policy neural network by adjusting the parameters of the action selection policy neural network to optimize the combined objective value.

2. The method of claim 1 wherein obtaining the data defining the updated version of the action selection policy:
maintaining a Q-value neural network configured to process an observation of a state and an action for the agent to generate a Q-value;
training the Q-value neural network by reinforcement learning, using the reinforcement learning technique based on the rewards, to optimize a first, task-related objective function; and
using the Q-value neural network to obtain the data defining the updated version of the action selection policy.

3. The method of claim 2 wherein the action selection policy neural network is configured to generate a policy output π(a|s) for selecting an action a to be performed by the agent in a state s of the environment, and wherein using the Q-value neural network to obtain the data defining the updated version of the action selection policy comprises multiplying π(a|s) by exp(Q(s,a)/η), where Q(s,a) is the Q-value from the Q-value neural network for action a and state s and η is a temperature parameter, to obtain the data defining the updated version of the action selection policy.

4. The method of claim 1, further comprising obtaining training data by, for each of one or more time steps:
obtaining an observation of the state of the environment;
processing the observation using the action selection policy neural network to generate a policy output;
selecting an action to be performed by the agent in response to the observation using the policy output;
causing the agent to perform the selected action and, in response, receiving a reward characterizing progress made on the task;
and obtaining the data defining the updated version of the action selection policy using the reinforcement learning technique based on the rewards received subsequent to the actions selected using the policy output.

5. The method of claim 4 comprising iteratively obtaining the training data, and training the action selection policy neural network.

6. The method of claim 1, wherein the data defining the second action selection policy comprises a dataset of transitions each comprising an observation characterizing a state of the environment at a time step, an action that was performed at the time step, and a reward received subsequent to performing the action; and wherein obtaining the data defining the updated version of the action selection policy uses the reinforcement learning technique based on the rewards in the dataset.

7. The method of claim 6 wherein determining the second policy projection value comprises sampling one or more observations of states of the environment from the dataset, sampling one or more actions corresponding to the sampled observations from the dataset, and averaging a logarithm of a policy output from the action selection policy neural network for each sampled state and action pair.

8. The method of claim 7 comprising averaging the logarithm of the policy output for each sampled state and action pair weighted by a state-action advantage value for the sampled state and action pair.

9. The method of claim 4 wherein the data defining the second action selection policy comprises data from a model policy output of an action selection model configured to process an input from an observation representing a state of the environment and to generate the model policy output for selecting an action for the agent.

10. The method of claim 9 wherein determining the second policy projection value comprises sampling one or more observations of states of the environment from the training data, determining one or more actions corresponding to the sampled observations according to the action selection policy defined by the action selection policy neural network and, for each sampled state and action pair, determining logarithm of a ratio of the model policy output from the action selection model for the sampled state and for the action, to the policy output from the action selection policy neural network for the sampled state and for the action.

11. The method of claim 10 wherein determining the second policy projection value further comprises averaging, over the determined states and actions, a product of a logarithm of the policy output network for the sampled state and for the action and an exponential function of the logarithm of the ratio.

12. The method of claim 4 wherein the data defining the second action selection policy is derived from a second Q-value neural network configured to process an observation of a state and an action for the agent to generate a second Q-value, the method further comprising training the second Q-value neural network by reinforcement learning using the training data to optimize a second, task-related objective function.

13. The method of claim 12 further comprising:
maintaining a further Q-value neural network configured to process an observation of a state and an action for the agent to generate a further Q-value, and training the further Q-value neural network by reinforcement learning using the training data to optimize a further, task-related objective function;
using the further Q-value neural network to obtain data defining a second updated version of the action selection policy for selecting an action for the agent in response to an observation of a state of the environment;
determining a third policy projection value dependent on a measure of a difference between the second updated version of the action selection policy and the action selection policy; and
determining the combined objective value from a weighted combination of the first policy projection value, the second policy projection value, and the third policy projection value.

14. The method of claim 1, wherein the first policy projection value and the second policy projection value each comprise a measure of a KL divergence.

15. The method of claim 1, wherein the weighted combination of the first policy projection value and the second policy projection value comprises a combination of the first policy projection value with a first weight and a combination of the second policy projection value with a second weight, the method further comprising adjusting the first and second weights to optimize the reward or return from the environment.

16. The method of claim 1, wherein the weighted combination of the first policy projection value and the second policy projection value is defined by a weight vector, the method further comprising:
processing the observation and the weight vector using the action selection policy neural network to generate the policy output; and
adjusting the weight vector to optimize the reward or return from the environment.

17. The method of claim 16, further comprising randomly sampling values for the weight vector during the training of the action selection policy neural network.

18. The method of claim 16, further comprising automatically adjusting the weight vector to optimize the rewards.

19. (canceled)

20. (canceled)

21. A system comprising one or more computers and one or more storage devices storing instructions that are operable, when executed by the one or more computers, to cause the one or more computers to perform operations for training an action selection policy neural network defining an action selection policy used to select actions to be performed by an agent to control the agent to perform a task in an environment, the task having multiple associated objectives, the operations comprising:
obtaining data defining an updated version of the action selection policy for selecting an action for the agent in response to an observation of a state of the environment, by using a reinforcement learning technique based on rewards received subsequent to selected actions;
obtaining data defining a second action selection policy for selecting an action for the agent in response to an observation of a state of the environment;
determining a first policy projection value dependent on a measure of a difference between the updated version of the action selection policy and the action selection policy;
determining a second policy projection value dependent on a measure of a difference between the second action selection policy and the action selection policy;
determining a combined objective value from a weighted combination of the first policy projection value and the second policy projection value; and
training the action selection policy neural network by adjusting the parameters of the action selection policy neural network to optimize the combined objective value.

22. A computer storage medium encoded with instructions that, when executed by one or more computers, cause the one or more computers to perform operations for training an action selection policy neural network defining an action selection policy used to select actions to be performed by an agent to control the agent to perform a task in an environment, the task having multiple associated objectives, the operations comprising:
obtaining data defining an updated version of the action selection policy for selecting an action for the agent in response to an observation of a state of the environment, by using a reinforcement learning technique based on rewards received subsequent to selected actions;
obtaining data defining a second action selection policy for selecting an action for the agent in response to an observation of a state of the environment;
determining a first policy projection value dependent on a measure of a difference between the updated version of the action selection policy and the action selection policy;
determining a second policy projection value dependent on a measure of a difference between the second action selection policy and the action selection policy;
determining a combined objective value from a weighted combination of the first policy projection value and the second policy projection value; and
training the action selection policy neural network by adjusting the parameters of the action selection policy neural network to optimize the combined objective value.
